(19) United States
(12) Patent Application Publication
(10) Pub. No.: US 2011/0225240 A1
(43) Pub. Date: Sep. 15, 2011

(54) METHOD AND APPARATUS FOR MANAGING TRANSACTION OF IPTV

(76) Inventors: Truong Cong THANG, Yuseong-gu (KR); Jung Won KANG, Seoul (KR); Seong Jun BAE, Yuseong-gu (KR); Jeong Ju YOO, Dong-gu (KR); Won RYU, Yusung-gu (KR)

(21) Appl. No.: 12/908,394

(22) Filed: Oct. 20, 2010

Related U.S. Application Data
(60) Provisional application No. 61/253,144, filed on Oct. 20, 2009.

(30) Foreign Application Priority Data
Oct. 20, 2010 (KR) 10-2010-0102335

(51) Int. Cl. G06F 15/16

(52) U.S. Cl. 709/204

(57) ABSTRACT

A method and apparatus for controlling a transaction in an entity employing a Moving Picture Experts Group eXtensible Middleware (MXM) transaction are provided. The transaction may include at least one sub-session, and the at least one sub-session may be hierarchically configured. A syntax for controlling hierarchical sub-sessions, a syntax of a transaction control message, and a syntax of a content transfer control message are disclosed.

### CROSS-REFERENCE TO RELATED APPLICATIONS

This application claims the benefit of Korean Patent Application No. 10-2010-0102335, filed on Oct. 20, 2010, in the Korean Intellectual Property Office, and U.S. Provisional Application No. 61/253,144, filed on Oct. 20, 2009, in the United States Patent and Trademark Office, the disclosures of which are incorporated herein by reference.

### BACKGROUND

1. Field of the Invention

The present invention relates to a method and apparatus for managing a transaction of an Internet Protocol Television (IPTV).

2. Description of the Related Art

An Internet Protocol Television (IPTV) emerges as a new infrastructure for broadcasting and Video-on-Demand (VoD) services.

It is expected that the future IPTV systems could accommodate all typical multimedia services.

To support interoperability in the IPTV market, IPTV standards have been developed. However, existing IPTV standards are rather limited in terms of architecture and provided services.

The main goal of Moving Picture Experts Group eXtensible Middleware (MXM) standards developed by MPEG is to provide normative Application Programming Interfaces (APIs) for various tasks in a media value chain.

A certain player may easily develop applications or services that will be provided to other players or consumers, by using normative APIs, even though that player does not know processing and transmission of media. For example, a service developer may develop a service with MPEG media without having expertise in media processing.

Accordingly, the MXM may be suitably used as a base for IPTV due to its efficiency and flexibility in providing services.

### SUMMARY

An aspect of the present invention provides a method and apparatus for controlling a transaction in a Moving Picture Experts Group eXtensible Middleware (MXM).

According to an aspect of the present invention, there is provided a method of managing a transaction between entities in a network based on a Moving Picture Experts Group eXtensible Middleware (MXM), the method including: establishing a transaction with an entity in the network; transmitting a request message to the entity; and receiving a reply message corresponding to the request message from the entity, wherein the transaction includes at least one sub-session, and the request message includes an identifier (ID) of the transaction, and an ID of one of the at least one sub-session executed in response to the request message.

The entity may include at least one of a content creator, a provider, and an end user.

A provider is any player participating in the content value chain, for example a content identification provider, a content/service description provider, an Intellectual Property Management and Protection (IPMP) tool provider, a delivery provider, a storage provider, an advertisement provider, and an adaptation provider.

The establishing may include performing an authentication with an entity, and reaching an agreement with the entity on a resource transfer protocol.

The at least one sub-session may include at least one level and may have at least one ID, and the at least one ID of the at least one sub-session may respectively correspond to the at least one level.

The transmitting and the receiving may be performed at least one time, and at least one request message transmitted at least one time may include different IDs of at least one sub-session.

The different IDs of the at least one sub-session may increase over time.

The request message and the reply message may include a same ID of the at least one sub-session.

The method may further include transmitting a transaction control message to an entity, the transaction control message being used to control the transaction.

The transaction control message may be used to tear down, pause, or resume all or a portion of the at least one sub-session of the transaction.

The transaction control message may include an electronic signature of the transaction control message.

The transaction control message may include an element representing a reason for a control action indicated by the transaction.

The transaction control message may include an element representing whether the control action is immediately performed without waiting for an acknowledge from the entity.

The transaction control message may include at least one of the ID of the transaction and the ID of one of the at least one sub-session, and the ID of the transaction and the at least one ID of the at least one sub-session may be used to identify a target of the control action.

The transaction control message may include an ID of a content, and may request a processing of the content to be torn down, paused, or resumed.

The transaction control message may include an ID of a content element, and may request a processing of the content element to be cancelled, paused, or resumed.

The method may further include receiving a transaction control reply message from the entity, the transaction control reply message including a processing status of the transaction control message.

The method may further include transmitting a content transfer control message to the entity, the content transmission control message being used to control a content transfer, wherein the content transfer control message includes a content item, a content element, and an ID of a service.

The content transfer control message may include an attribute indicating a direction of a control of the content transfer, and an attribute indicating a scale factor used to compute a content display speed.

According to another aspect of the present invention, there is provided an entity in a network based on MXM, the entity including: a transceiving unit to transmit a request message to a counterpart entity, and to receive a reply message corresponding to the request message from the counterpart entity, the entity and the counterpart entity establishing a transaction; and a control unit to process the reply message and to generate the request message, wherein the transaction may include at least one sub-session, and the request message includes an ID of the transaction, and an ID of one of the at least one sub-session executed in response to the request message.

### EFFECT

According to embodiments of the present invention, it is possible to control a transaction in a Moving Picture Experts Group eXtensible Middleware (MXM).

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an Internet Protocol Television (IPTV) system based on a Moving Picture Experts Group eXtensible Middleware (MXM) according to an embodiment of the present invention;

FIG. 2 is a flowchart illustrating an MXM transaction management method according to an embodiment of the present invention; and

FIG. 3 is a block diagram illustrating an MXM network entity according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

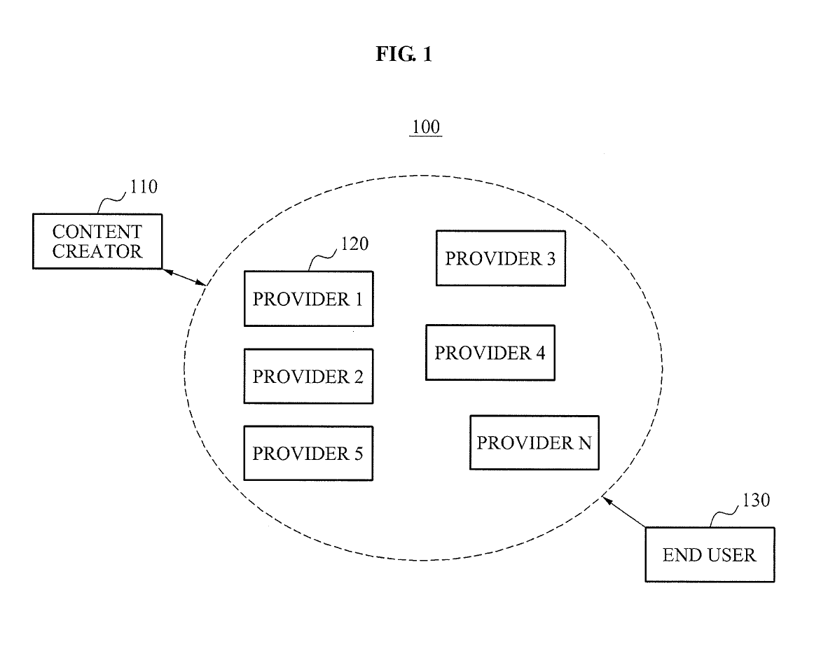

FIG. 1 is a diagram illustrating an Internet Protocol Television (IPTV) system 100 based on a Moving Picture Experts Group eXtensible Middleware (MXM) according to an embodiment of the present invention.

The IPTV system 100 of FIG. 1 may include a content creator 110, a provider 120, and an end user 130.

Hereinafter, the content creator 110, the provider 120, and the end user 130 will be referred to as entities (or parties). In other words, an entity may be at least one of the content creator 110, the provider 120, and the end user 130.

Referring to FIG. 1, a dotted circle between the content creator 110 and the end user 130 may indicate that a plurality of providers including the provider 120 may be included in the IPTV system 100.

The provider 120 may refer to an entity for providing basic services, for example a content identification provider, a content/service description provider, an Intellectual Property Management and Protection (IPMP) tool provider, a delivery provider, a storage provider, an advertisement provider, an adaptation provider, and the like.

To form the entire value chain from a content provider to an end user, a large number of protocols between involved entities need to be defined. Basic protocols between a content creator, a content provider, a content identification provider, and end users have been defined by the MXM.

However, current protocols have very little functions to manage transactions between entities.

Accordingly, there is a desire to support a complex delivery of contents/services in advanced IPTV systems, by providing a method of managing transactions in MXM protocols.

Among apparatuses and methods according to embodiments of the present invention, apparatuses and methods other than an apparatus and method for controlling content transfer may be applied to all types of transactions, for example, content/metadata transfer, IPMP tool requests, and domain management.

In conventional MXM standards, during a single transaction (or a session), at most one request message may be transmitted at a predetermined time. In other words, when a single entity desires to make at least two requests, a new transaction needs to be established.

Each transaction may require a mutual authentication and some common procedures between at least two entities. The common procedures may include, for example, a procedure of reaching an agreement on a resource transfer protocol. Accordingly, repeated occurrences of transactions of the same protocol may be very inefficient.

Hereinafter, sub-sessions and a method of identifying sub-sessions will be described.

In embodiments of the present invention, at least one request (or at least one sub-session) may be performed during a single transaction.

In other words, at least one sub-transaction (or at least one sub-session) may exist within a single transaction.

Each transaction may be identified by a TransactionID element defined by an MXM protocol type.

To distinguish a message of a predetermined sub-session from messages of other sub-sessions, an identifier (ID) for each message, that is, a sub-session ID may be used. Basically, the sub-session ID may be used to identify a sub-transaction (or a sub-session) executed by a predetermined request message.

At least one level may exist within a sub-session. In other words, at least one lower sub-session may exist within an upper sub-session. Sub-sessions may be hierarchically configured.

To enable multiple levels in sub-sessions, at least one subsessionID element may be employed. SubsessionIDs may respectively correspond to levels of a sub-session. A subsessionID of an X-th level may be denoted by lvXsubsessionID.

For example, a sub-session identified by lv2subsessionID may be included in a sub-session identified by lv1subsessionID, and the sub-session identified by lv1subsessionID may be included in a session identified by TransactionID.

In a sub-session of level X, subsessionID may be used by the following two rules:

1) A request message sent later may have a value of subsessionID higher than that of an earlier request message. When a subsessionID value reaches a maximum value supported by a syntax, a value of a next subsessionID may be started over from 0. In other words, subsessionID may increase over time.

2) A reply message including an acknowledge (Ack) message in response to a received message may have the same subsessionID as that of the received message.

An instance of a syntax of a modified MXM ProtocolType is shown in Table 1 below. The modified MXM ProtocolType may be obtained by modifying an existing MXM ProtocolType to identify messages.

TABLE 1
<complexType name=“ProtocolType” abstract=“true”/>

<complexContent>

<extension base=“mxmbp:ProtocolBaseType”>

<sequence>

<element name=“TransactionID”
type=“string”/>

</sequence>

</extension>
<attribute name=“lv1subsessionID” type=“int” use=“optional”/>
<attribute name=“lv2subsessionID” type=“int” use=“optional”/>

</complexContent>

</complexType>

As shown in Table 1, the syntax of the modified MXM ProtocolType may include an ID of a sub-session.

Two optional attributes, namely lv1subsessionID and lv2subsessionID, may be added to the MXM ProtocolType. In the syntax of Table 1, lv1subsessionID and lv2subsessionID may be of integer type.

Different types of syntaxes other than the syntax of Table 1 may serve the same purpose of the syntax of Table 1. For example, subsessionID may be an element similar to TransactionID. Additionally, subsessionID may be of string type rather than integer type.

Hereinafter, general transaction controls will be described.

The conventional MXM specifications do not support general transaction controls, such as teardown (or cancel), pause, and the like. Accordingly, a request may be inefficiently processed.

For example, due to limitations of resources, an entity involved in a transaction may request another entity to cancel a transaction or session. If this controls is not provided, some entities may continue to perform a task that may not be used, for example a task of uploading a file and the like.

In embodiments of the present invention, a transaction control message used to control all MXM transactions will be described. A transaction control message may have three types, for example, teardown (or cancel), pause, and resumption. As the names of the three message types imply, a teardown message, a pause message, and a resume message may be respectively used to tear down, to pause, and to resume all or a portion of sub-sessions of a single transaction (or a single session).

Each transaction control message may include at least one of parameters of Table 2 below.

TABLE 2

| Parameters | Functions of parameters |
|---|---|
| diag:Signature | diag:Signature element as an optional element |
| | contains a digital signature of the whole |
| | message, similarly to other MXM protocol |
| | messages. |
| Reason | Reason is an element of |
| | mxmbp:ProtocolResultType, |
| | and conveys a reason for a control action |
| side | side indicates an entity (or a side (party)) that |
| | has a boolean attribute and that first carries |
| | the control action. |
| | A TRUE value means that an entity sending a |
| | message desires to announce that it has to |
| | immediately perform the control action (e.g., |
| | cancel) without waiting for an acknowledge from |
| | other entities. Here, other involved entities |
| | need to act correspondingly. |
| | A FALSE value means that an entity sending a |
| | message requests other entities to perform the |
| | control action (e.g. cancel) first. |
| | Here, other involved entities need to act |
| | correspondingly, and send an Ack message to the |
| | requesting entity. |
| | In other words, the side element represents |
| | whether an entity immediately performs the |
| | control action without waiting for a response |
| | from a counterpart entity that receives a |
| | transaction control message. |
| TransactionID | TransactionID is inherited from the MXM |
| | ProtocolType. |
| | For example, when a control message includes only |
| | TransactionID without other elements, the whole |
| | transaction is asked to be cancelled, paused, or |
| | resumed, based on the type of control message. |
| lxXsubsessionID | X may have a value of 1 or 2. |
| | lxXsubsessionID is inherited from the modified |
| | MXM ProtocolType. |
| | For example, when a control message contains only |
| | TransactionID and lvXsubsessionID elements |
| | without other elements, the whole sub-session (or |
| | sub-transaction) identified by TransactionID and |
| | lvXsubsessionID is asked to be cancelled, paused, |
| | or resumed, based on the type of control message. |
| | In other words, TransactionID and lvXsubsessionID |
| | elements may indicate a control target of the |
| | control message. |
| ContentID | ContentID indicates an ID of a content item. |
| | For example, when a control message contains |
| | ContentID, a processing of a corresponding |
| | content item (for example, uploading, or |
| | adaptation) is asked to be cancelled, paused, or |
| | resumed, based on the type of control message. |
| ContentElementID | ContentElementID indicates an ID of a content |
| | element (for example, a resource). |
| | For example, when a control message contains |
| | ContentElementID, a processing of a corresponding |
| | content element (for example, uploading, or |
| | adaptation) is asked to be cancelled, paused, or |
| | resumed, based on the type of control |
| | message. |

An instance of a syntax of a control message (TeardownType, PauseType, and ResumeType) is shown in Table 3 below. Different types of syntaxes may serve the same purpose of the syntax of Table 3.

TABLE 3
<complexType name=“TeardownType”>

<complexContent>

<extension base=“mxmbp:ProtocolType”>

<sequence>

<element name=“ControlInfo” type=“TransactionControlType”

minOccurs=“0” maxOccurs=“unbounded”/>

<element ref=“dsig:Signature” minOccurs=“0”/>

</sequence>
<attribute name=“side” type=“boolean” use=“optional”/>

</extension>

</complexContent>

</complexType>
<complexType name=“PauseType”>

<complexContent>

<extension base=“mxmbp:ProtocolType”>

<sequence>

<element name=“ControlInfo” type=“TransactionControlType”

minOccurs=“0” maxOccurs=“unbounded”/>

<element ref=“dsig:Signature” minOccurs=“0”/>

</sequence>
<attribute name=“side” type=“boolean” use=“optional”/>

</extension>

</complexContent>

</complexType>
<complexType name=“ResumeType”>

<complexContent>

<extension base=“mxmbp:ProtocolType”>

<sequence>

<element name=“ControlInfo” type=“TransactionControlType”

minOccurs=“0” maxOccurs=“unbounded”/>

<element ref=“dsig:Signature” minOccurs=“0”/>

</sequence>

<attribute name=“side” type=“boolean” use=“optional”/>
</extension>

</complexContent>

</complexType>
<complexType name=“TransactionControlType”>

<complexContent>

<extension base=“mxmbp:ProtocolBaseType”>

<sequence>

<element name=“ContentID” type=“anyURI” minOccurs=“0”

maxOccurs=“unbounded”/>

<element name=“ContentElementID” type=“anyURI” minOccurs=“0”

maxOccurs=“unbounded”/>

<element name=“Reason” type=“mxmbp:ProtocolResultType”

minOccurs=“0”/>

</sequence>

</extension>

</complexContent>

</complexType>

Hereinafter, general content transfer controls will be described.

A content transfer control message may be used to specifically control a content transfer between entities.

The content transfer control message may be of a ContentTransferControlType that may specify both forward-moving and backward-moving requests. Such a content transfer control may be used to support trick modes in content consumption.

Each type of content transfer control message may include at least one of parameters of Table 4 below.

TABLE 4

| Parameters | Functions of parameters |
|---|---|
| dsig:Signature | diag:Signature element as an optional element contains a |
| | digital signature of the whole message, similarly to |
| | other MXM protocol messages. |
| ContentControl | ContentControl is an element to represent control |
| | information for a group of content items or a group of |
| | elements. |
| ContentID | ContentID is an element to indicate an ID of a content |
| | item, an ID of a content element, or an ID of a service |
| | that enables media content to be played back on a screen. |
| | ContentID is controlled by the following attributes, |
| | namely direction and scale. |
| direction | direction has a boolean value and is an attribute |
| | indicating a direction of transfer control. |
| | A TRUE value means a forward-moving control, and a |
| | FALSE value means a backward-moving control. |
| scale | scale is an attribute indicating a scale factor to |
| | compute a display speed of a new content. |
| | A requested new playback speed is calculated by |
| | multiplying an existing playback speed by the scale |
| | factor. For example, if a scale factor is 2, a playback |
| | speed may be doubled. |

An instance of a syntax of a control message (TeardownType, PauseType, and ResumeType) is shown in Table 5 below. Different types of syntaxes may serve the same purpose of the syntax of Table 5.

TABLE 5
<complexType name=“ContentTransferControlType”>

<complexContent>

<extension base=“mxmbp:ProtocolType”>

<sequence>

<element name=“ContentControl”
type=“ContentControlType”

minOccurs=“0” maxOccurs=“unbounded”/>

<element ref=“dsig:Signature” minOccurs=“0”/>

</sequence>

</extension>

</complexContent>

</complexType>
<complexType name=“ContentControlType”>

<complexContent>

<extension base=“mxmbp:ProtocolBaseType”>

<sequence>
<element name=“ContentID” type=“anyURI”

minOccurs=“0” maxOccurs=“unbounded”/>

</sequence>
<attribute name=“direction” type=“boolean”
use=“required”/>
<attribute name=“scale” type=“float” use=“required”/>

</extension>

</complexContent>

</complexType>

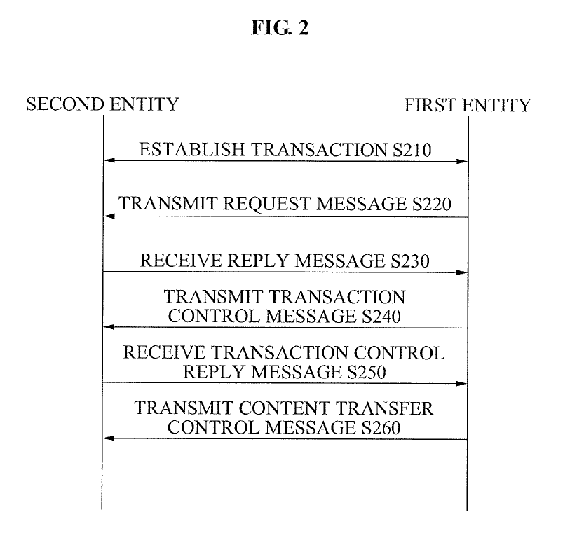

FIG. 2 is a flowchart illustrating an MXM transaction management method according to an embodiment of the present invention.

A first entity and a second entity may be involved in a transaction.

In operation S210, the first entity and the second entity may establish the transaction.

As described above, the transaction may include at least one sub-session.

In operation S210, an authentication between the first entity and the second entity may be performed.

Additionally, in operation S210, an agreement on a resource transfer protocol may be reached between the first entity and the second entity.

In operation S220, the first entity may transmit a request message to the second entity.

In operation S230, the first entity may receive a reply message corresponding to the request message from the second entity.

Each of the request message and the reply message may include TransactionID as an ID of a transaction, and subsessionID as an ID of a sub-session. Specifically, subsessionID may include, for example lv1subsessionID and lv2subsessionID that are used as IDs of sub-sessions.

The sub-session may include at least one level. Since each level requires a single ID of a sub-session, at least one sub-session may have at least one ID. The at least one ID of the at least one sub-session may respectively correspond to at least one level.

In a single transaction, operations S220 and S230 may be performed at least one time. IDs of sub-sessions included in request messages may differ from IDs of sub-sessions included in reply messages.

In operation S240, the first entity may transmit a transaction control message to the second entity. Here, the transaction control message may be used to control a transaction.

The transaction control message may be used to request or declare a control action such as a cancel, a pause, and a resumption.

The transaction control message may have the same ID of the transaction as the request message transmitted in operation S220 and the reply message received in operation S230.

When a digital signature exists in the transaction control message, the second entity receiving the transaction control message may verify the digital signature.

The second entity may process the received transaction control message, and may send back an Ack message to inform a processing status.

In operation S250, the first entity may receive a transaction control reply message from the second entity. The transaction control reply message may be an Ack message including a processing status of the transaction control message.

In operation S260, the first entity may transmit a content transfer control message to to the second entity.

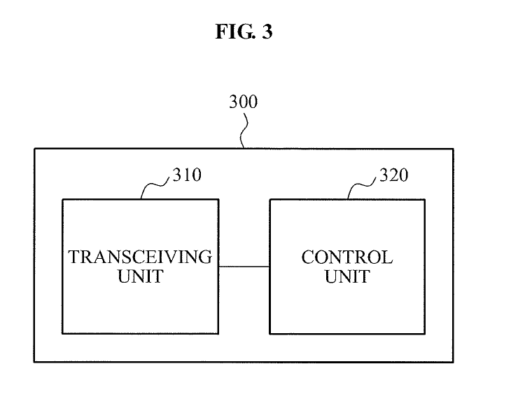

FIG. 3 is a block diagram illustrating an MXM network entity according to an embodiment of the present invention.

An entity 300 may include a transceiving unit 310 and a control unit 320.

The transceiving unit 310 may transmit and receive messages required for transaction establishment.

The transceiving unit 310 may transmit a request message, a transaction control message, and a content transfer control message, and may receive a reply message and a transaction control reply message.

The control unit 320 may generate a message to be transmitted, and may process a received message.

For example, the control unit 320 may analyze the reply message and the transaction control reply message, may perform a task based on the analyzed message, and may generate a request message, a transaction control message, and a content transfer control message.

Technical descriptions given with reference to FIGS. 1 and 2 may equally be applied to embodiments of the present invention and accordingly, further detailed descriptions will be omitted herein.

The methods according to the embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

### DESCRIPTION OF REFERENCE NUMERALS

100: IPTV system
300: MXM network entity

What is claimed is:

1. A method of managing a transaction between entities in a network based on a Moving Picture Experts Group eXtensible Middleware (MXM), the method comprising:
establishing a transaction with an entity in the network;
transmitting a request message to the entity; and
receiving a reply message corresponding to the request message from the entity,
wherein the transaction comprises at least one sub-session, and the request message comprises an identifier (ID) of the transaction, and an ID of one of the at least one sub-session executed in response to the request message.

2. The method of claim 1, wherein the entity comprises at least one of a content creator, a content provider, a content identification provider, and an end user.

3. The method of claim 2, wherein the content provider comprises at least one of a content identification provider, a content/service description provider, an Intellectual Property Management and Protection (IPMP) tool provider, a delivery provider, a storage provider, an advertisement provider, and an adaptation provider.

4. The method of claim 1, wherein the establishing comprises:
performing an authentication with the entity; and
reaching an agreement with the entity on a resource transfer protocol.

5. The method of claim 1, wherein the at least one sub-session comprises at least one level and has at least one ID, and the at least one ID of the at least one sub-session respectively corresponds to the at least one level.

6. The method of claim 1, wherein the transmitting and the receiving are performed at least one time, and at least one request message transmitted at least one time comprises different IDs of at least one sub-session.

7. The method of claim 6, wherein the different IDs of the at least one sub-session increase over time.

8. The method of claim 1, wherein the request message and the reply message comprise a same ID of the at least one sub-session.

9. The method of claim 1, further comprising:
transmitting a transaction control message to the entity, the transaction control message being used to control the transaction.

10. The method of claim 9, wherein the transaction control message is used to tear down, pause, or resume all or a portion of the at least one sub-session of the transaction.

11. The method of claim 9, wherein the transaction control message comprises an electronic signature of the transaction control message.

12. The method of claim 9, wherein the transaction control message comprises an element representing a reason for a control action indicated by the transaction.

13. The method of claim 9, wherein the transaction control message comprises an element representing whether the control action is immediately performed without waiting for an acknowledge from the entity.

14. The method of claim 9, wherein the transaction control message comprises at least one of the ID of the transaction and the ID of one of the at least one sub-session, and the ID of the transaction and the at least one ID of the at least one sub-session are used to identify a target of the control action.

15. The method of claim 9, wherein the transaction control message comprises an ID of a content, and requests the content to be torn down, paused, or resumed.

16. The method of claim 9, wherein the transaction control message comprises an ID of a content element, and requests a processing of the content element to be cancelled, paused, or resumed.

17. The method of claim 9, further comprising:
receiving a transaction control reply message from the entity, the transaction control reply message comprising a processing status of the transaction control message.

18. The method of claim 1, further comprising:
transmitting a content transfer control message to the entity, the content transmission control message being used to control a content transfer,
wherein the content transfer control message comprises a ID of content item, a ID of content element, or an ID of a service.

19. The method of claim 18, wherein the content transfer control message comprises an attribute indicating a direction of a control of the content transfer, and an attribute indicating a scale factor used to compute a content display speed.

20. An apparatus for processing a transaction in a network based on a Moving Picture Experts Group eXtensible Middleware (MXM), the entity comprising:
a transceiving unit to transmit a request message to a counterpart entity, and to receive a reply message corresponding to the request message from the counterpart entity, the entity and the counterpart entity establishing a transaction; and
a control unit to process the reply message and to generate the request message,
wherein the transaction comprises at least one sub-session, and the request message comprises an identifier (ID) of the transaction, and an ID of one of the at least one sub-session executed in response to the request message.
